(19) United States
(12) Patent Application Publication
(10) Pub. No.: US 2024/0006676 A1
(43) Pub. Date: Jan. 4, 2024

(54) Direct Regeneration of Spent Graphite Anode of Lithium-ion Battery

(71) Applicant: THE REGENTS OF THE UNIVERSITY OF CALIFORNIA, Oakland, CA (US)

(72) Inventors: Zheng CHEN, San Diego, CA (US); Panpan XU, San Diego, CA (US)

(73) Assignee: THE REGENTS OF THE UNIVERSITY OF CALIFORNIA, Oakland, CA (US)

(21) Appl. No.: 18/037,289

(22) PCT Filed: Nov. 16, 2021
(86) PCT No.: PCT/US2021/059584

§ 371 Date: May 16, 2023

(51) Int. Cl. H01M 10/54; H01M 4/04; H01M 4/583; H01M 10/0525

(52) U.S. Cl. CPC H01M 10/54; H01M 4/0471; H01M 4/583; H01M 10/0525; H01M 2004/027

(57) ABSTRACT

A method for restoring electrochemical activity and cycling stability to spent graphite anode material for a lithium-ion battery includes exposing powdered graphite anode material to boric acid to form borated material, then sintering the borated material. The processing removes dead lithium from the bulk structure and applies boron doping to surfaces of the graphite material.

### RELATED APPLICATIONS

This application claims the benefit of the priority of U.S. Provisional Application No. 63/114,502, filed Nov. 16, 2020, which is incorporated herein by reference in its entirety.

### GOVERNMENT RIGHTS

This invention was made with government support under Grant No. CBET-1805570 awarded by the National Science Foundation and a ReCell Center grant awarded by the Department of Energy. The government has certain rights in the invention.

### FIELD OF THE INVENTION

The present invention relates to a method for the direct regeneration and upcycling of spent graphite anode particles of lithium ion batteries.

### BACKGROUND OF THE INVENTION

Lithium-ion batteries (LIBs) have been extensively used as the power source for portable electronics and electric vehicles (EVs) because of their high energy density and long cycle life. It is projected that the global LIB production will reach ˜440 GWh by 2025, corresponding to a market value of ˜$100 billion USD. Given that the typical life-span of LIBs is 3-10 years, large amounts of LIBs will be retired in the near future. Like the plastic waste issues the world is facing today, if immediate action is not taken, battery wastes will pose an enormous challenge to our society. In this context, recycling is regarded as an effective closed-loop solution to mitigate environmental issues associated with inappropriate disposal of spent batteries and to recover valuable materials. Current commercial LIB recycling techniques, including hydrometallurgical and pyrometallurgical processes, focus on reclaiming the metal elements (Li, Co, Ni, and Mn) contained in their cathodes. However, the anode material (mainly graphite), which accounts for up to 20% of the total weight of a typical LIB cell, is either burned or discarded in a landfill. This non-ideal practice not only releases large amounts of greenhouse gases, but also inefficiently disposes of a material that otherwise retains the ability to provide electrochemical energy, which is much more efficient than combustion. Industry does not currently practice graphite cycling partially due to its relatively low cost (6˜10$/kg) compared to transition metal oxide cathode (e.g., ˜20$/kg for LiNi_{0.5}Co_{0.2}Mn_{0.3}O₂). A sustainable process for anode recycling that maximizes the overall value with minimal operating cost is highly desirable.

Generally, the capacity degradation of LIBs can be attributed to the loss of Li inventory with some structural changes that can result from the formation of solid-electrolyte interphase (SEI) on the surface of graphite particle, chemical destruction of cathode materials, and mechanical failure due to repeated volume changes in both electrodes. Notably, in spite of capacity degradation from spent graphite anodes, their morphology and bulk structure are often maintained. Some prior efforts have been made to rejuvenate spent graphite electrodes through the removal of SEI using strong caustic acids (e.g., HCl, H₂SO₄) followed by high-temperature annealing. However, the use of strong acids poses a secondary pollution concern. In addition, even with using extremely high annealing temperature (e.g., >1500° C.), the capacity of recycled graphite remained inferior to the pristine ones, making them inappropriate for fabrication of high quality new cells.

### BRIEF SUMMARY

The present invention is directed to an environmentally benign method to regenerate and upcycle spent graphite anode particles, moving toward the goal of eliminating environmental concerns caused by existing spent Li-ion battery recycling approaches while providing sustainable sources of raw materials for Li-ion battery fabrication. According to the inventive method, spent graphite particles were regenerated through a series of steps that includes washing, sintering, pre-treatment before sintering. This method is based in part upon the finding that large amounts of dead-Li residual are present inside the graphite particles, such that conventional washing or sintering cannot regenerate the graphite particle to a level of fresh graphite particle. The inventive approach includes a pre-treatment with boric acid that can effectively remove the dead-Li residual inside the graphite particle. By following the boric acid pre-treatment with a short annealing step, the boron is incorporated into the surface of the graphite particle. This method not only eliminates the dead-Li residual inside the graphite particle but also modifies the surface of graphite particle with boron doping, which effectively recovers the battery performance of spent graphite particle to a level similar to or higher than that of commercial graphite.

In one aspect of the invention, a method for removing bulk defects from spent graphite particles from a Li-ion battery anode includes treating the spent graphite particles in a boric acid solution to form borated graphite particles; drying the borated graphite particles; and fast annealing the borated graphite particles. Prior to the step of treating, the spent graphite particles may be washing in a solvent and dried to form a powder. The step of fast annealing may include sintering the borated graphite particles for approximately an hour at a temperature in a range of 750° C. to 1050° C.

In another aspect of the invention, a method for restoring electrochemical activity and cycling stability to spent graphite anode material for use in a lithium-ion battery includes exposing powdered graphite anode material to boric acid to form borated material; and sintering the borated material, wherein dead lithium in a bulk structure of the graphite anode material is extracted and boron doping is applied to surfaces of the graphite material.

In some embodiments, prior to the step of exposing, the spent graphite particles may be washed in a solvent and dried to form a washed powder. The step of sintering includes annealing the borated material for approximately at least one hour at a temperature in a range of 750° C. to 1050° C.

In still another aspect of the invention, a method for regeneration of spent anode material of a lithium-ion battery includes harvesting graphite particles from the spent anode material; washing the harvested graphite particles in a solvent solution; precipitating graphite powder from the solution; rinsing the graphite powder in water; drying the graphite powder; dispersing the graphite powder in a boric acid solution; exposing the borated graphite powder to a drying temperature until dry; and sintering the dried borated graphite powder at a sintering temperature for a sintering period. In some embodiments, washing the graphite particles in the solvent solution further comprises heating the solution at a temperature of 70-90° C. until dried. The sintering temperature is within a range of 750° C. to 1050° C. The sintering period is at least one hour.

In yet another aspect of the invention, a method for removing bulk residual lithium and reopening channels for lithium transport from graphite anode material of a spent Li-ion battery comprises exposing powdered graphite anode material to boric acid to form borated material; and sintering the borated material, wherein boron doping is applied to surfaces of the graphite material. The step of sintering may include annealing the borated material for at least one hour at a temperature range of 750° C. to 1050° C.

The inventive method for direct recycling of spent graphite particles for a lithium-ion battery was demonstrated effective through a process involving disassembling a cycled (spent) pouch cell with a capacity of 20 Ah in a glove box filled with an inert gas, e.g., argon. The battery's anode strip was soaked in an appropriate solvent and heated for 2 hours, after which the anode material was scraped from the copper current collector, washed with solvent several times, and kept in a vacuum oven at 120° C. for 8 hours. The spent graphite anode was referred to as “C-Graphite”. The C-Graphite was regenerated with water washing, with the resulting material (washed graphite) being referred to as “W-Graphite”. The W-Graphite was sintered at 1050° C. for 1 h. The C-Graphite was pretreated with boric acid before sintering at different temperatures of 750° C., 850° C., 950° C. and 1050° C. for 1 h. These samples were referred to as “B-Graphite”.

The graphite material before and after regeneration were characterized with scanning electron microscopy (SEM), X-ray diffraction (XRD), X-ray photoelectron spectroscopy (XPS), thermogravimetric analysis (TGA), differential scanning calorimetry (DSC), scanning transmission electron microscopy (STEM)-electron energy loss spectroscopy (EELS). For electrochemical measurement, the graphite materials before and after recycling were mixed with a binder, e.g., polyvinylidene fluoride (PVDF), and conductive carbon black, e.g., TIMCAL Super P®, with a ratio of 8:1:1 in N-methyl-2-pyrrolidone (NMP) solvent to make a uniform slurry. The slurry was cast on a copper current collector and dried in a vacuum oven at 120° C. for 6 hours. A 2032-type half-cell was assembled with each graphite material as the anode, lithium foil as the cathode, and LP40 electrolyte (1M LiPF₆ in ethylene carbonate/diethyl carbonate) as the electrolyte.

Using advanced microscopic and spectroscopic techniques, the critical role of inactive Li-trapped in the structure defects of bulk graphite particles on lithium storage capacity was determined. Importantly, while washing plus annealing treatment can remove surface residual Li, the inactive Li trapped in the bulk of graphite particles remains, showing the need for additional processing.

The inventive direct regeneration approach involves boric acid pretreatment followed by fast annealing, which not only heals the graphite surface but also completely removes bulk defects of spent graphite particles. An in-situ formed boron-based surface coating further improves both the thermal and electrochemical stability of the regenerated graphite, which leads to upgraded anode with high capacity, high rate, and stable cycling performance.

The use of non-volatile and non-toxic boric acid (H₃BO₃) in the recycling process presents a significant advantage over other caustic acids such as HCl and H₂SO₄, in that it is a greener and more efficient route for sustainable recycling and upcycling of spent LIB anodes.

### BRIEF DESCRIPTION OF THE DRAWINGS

FIGS. 1A-1D are SEM images at different magnifications of C-, W-, S- and B-Graphite respectively.

FIG. 2 plots XRD patterns of C-, W-, S- and B-Graphite.

FIG. 3A shows XPS survey spectra of C-, W-, S- and B-Graphite; FIGS. 3B-3D are high-resolution XPS spectra of C1s (3a), O1s (3b) and B1s (3c) of C-, W-, S- and B-Graphite.

FIGS. 4A-4D are HAADF-STEM images and EELS elemental mapping of C-, W-, S- and B-Graphite respectively; FIG. 4E shows normalized Li concentration quantified from EELS mapping of different graphite samples.

FIGS. 5A-5C are plots of STEM-EELS of Li K-edge (FIG. 5A), and C K-edge (FIG. 5B) of C-, W-, S- and B-Graphite; FIG. 5C shows the B K-edge of B-Graphite.

FIGS. 6A-6H are N₂ adsorption/desorption isotherms at different annealing temperatures ranging from 750° C. to 1050° C., for B-Graphite (FIGS. 6A-6D) and S-Graphite (FIGS. 6E-6G); FIG. 6I provides a comparison of the surface area of B-Graphite and S-Graphite sintered at different temperatures.

FIG. 7 provides TGA and DSC curves of C-, W-, S- and B-Graphite.

FIG. 8A shows the cycling stability of B-graphite sintered at different temperatures;

FIG. 8B shows charge/discharge curves for C-, W-, S- and B-Graphite.

FIG. 9A plots cycling stability of C-, W-, S- and B-Graphite; FIG. 9B illustrates rate capability of C-, W-, S- and B-Graphite obtained at 1050° C. sintering.

FIG. 10 provides Nyquist plots of C-, W-, S- and B-Graphite. The inset illustrates the equivalent circuit.

FIG. 11 illustrates a scheme of cycled graphite (a) after different phases of treatment, including washing (b), sintering after washing (c) and boric treatment followed by sintering (d).

### DETAILED DESCRIPTION OF EMBODIMENTS

Degraded graphite powder from a cycled LIB anode was harvested from a spent pouch cell (General Motor's Chevrolet Volt EV cell, 20 Ah). After manual disassembly, the anode strips were rinsed with a first solvent before the graphite powder was scraped from the copper current collector. While a number of different solvents may be used for this rinsing step, in the testing described herein, dimethyl carbonate (DMC) was selected for use as the first solvent, due at least in part to its relatively eco-friendly composition. The collected graphite powder (“C-graphite”) was further washed with a small amount of a second solvent under stirring and mild heating (80° C.) for 5 hr to dissolve the polyvinylidene fluoride (PVDF) binder and separate carbon black conductive agent. A number of different solvents may be used in this second solvent rinse step including, for example, acetone, or N-methyl-2-pyrrolidone (NMP), an polar aprotic solvent commonly used for cleaning and stripping, and previously reported for use in lithium extraction. In the experiments described herein, NMP was used due to its ready availability, however, given the broad goal of a “green” approach to recycling (and the fact that NMP has been found to be reprotoxic and banned in the European Union), as will be readily apparent to those in the art, more environmentally-friendly alternatives may be selected as solvents to dissolve the binder, including but not limited to, for example, other pyrrolidones (Nn-butylpyrrolidone, N-isobutylpyrrolidone, Nt-butylpyrrolidone, NN-pentylpyrrolidone, N-(methyl-substituted butylpyrrolidones), dimethyl ester (DME)-based solvents, dipropylene glycol dimethyl ether (DPGDME), polyglyme, ethyl diglyme and 1,3-dioxolane, and bio-based solvents such as 2,2,5,5-tetramethyloxolane (TMO), dihydrolevoglucosenone (Cyrene™), and other. After centrifuging at 3500 rpm for about min, the C-graphite precipitation was then washed with distilled water. The black powder collected from a second centrifuging was dried under vacuum at relatively low temperature, e.g., 70-90° C., for about 10 or more hours. For testing, 80° C. for 12 hours was used, with the key criteria being that a well-dried dry powder was produced. The obtained graphite was designated as “washed graphite”, or “W-Graphite”.

Graphite regeneration was then conducted by treating the W-Graphite in a boric acid solution followed by short thermal annealing. An approximately 2:1 mixture of boric acid solution to graphite powder was used. For testing, the 1 g of W-graphite was dispersed in 2 mL of 5 wt. % boric acid solution, which was then dried at relatively low temperature for a sufficient time to fully dry the powder. As in the preceding step used in testing, 80° C. for 12 hours was used. The dried graphite was then sintered (annealed) at a range of higher temperatures in a nitrogen atmosphere for at least 1 hour, e.g., 1 to 10. Different temperatures were used for the sintering step were: 750° C. (B-750C-Graphite), 850° C. (B-850C-Graphite), 950° C. (B-950C-Graphite), and 1050° C. (B-1050C-Graphite), respectively. For comparison, W-graphite was also sintered at the same temperatures without any coating or doping, which was designated as “sintered graphite”, or “S-Graphite”, producing samples for 750° C. (S-750-Graphite), 850° C. (S-850-Graphite), 950° C. (S-950-Graphite), and 1050° C. (S-1050S-Graphite) for at least one 1 hour, respectively.

The morphology of the graphite particles produced during the experiments was characterized using SEM imaging (FEI XL30). The crystal structure of the powders was examined by XRD on a Bruker D2 Phaser diffractometer (Cu Kα radiation, λ=1.5406 Å).

The XPS measurement was performed with Kratos AXIS Ultra DLD with Al Kα radiation to detect the elemental valence states. Specific surface areas of the samples were measured using the BET method with an Autosorb IQ, Quantachrome ASIQM. STEM-EDS mapping was performed on primary particles using a JEOL JEM-2800 at annular dark field (ADF) mode. All ADF images were acquired at 200 kV with a beam size of A. STEM-EELS was performed on JEOL JEM-ARM300CF at 300 kV, equipped with double correctors. To minimize possible electron beam irradiation effects, EELS spectra were acquired from areas without pre-beam irradiation.

Graphite electrodes were prepared by mixing different graphite samples, PVDF, and conductive carbon black, e.g., TIMCAL Super P®, with a weight ratio of 8:1:1 in NMP solvent under stirring for 90 minutes to obtain a homogenous slurry, which was then cast onto a 12 μm thick copper foil followed by vacuum drying at 120° C. for 6 hours. The electrodes were cut into 12 mm diameter discs, pressed, then assembled into half cells with lithium metal as counter electrode and LP40 electrolyte (1M LiPF₆ in EC/DEC). Typical mass loading of graphite electrodes was controlled at −5 mg/cm². The half-cell cycling was carried out by constant current charging and discharging at different rates from 0.01 to 1.5 V with a LANDT multi-channel battery cycler. Electrochemical impedance spectroscopy (EIS) tests were performed in the frequency range of 10⁶ Hz to 10⁻³ Hz with a signal amplitude of 10 mV by using a Metrohm Autolab potentiostat.

To demonstrate the inventive recycling approach, spent pouch cells (20 Ah per cell) from a General Motor Chevrolet® Volt® EV were disassembled in an inert atmosphere. In this case, an argon-filled glovebox was used. Degraded graphite powders were harvested from the anodes following the procedure described above. The collected spent graphite powders (referred to as “C-Graphite”) were subject to different regeneration processes, including washed with solvent and water (referred to as “W-Graphite”), sintering after prior washing (referred to as “S-Graphite”), and washed with boric acid solution followed by short sintering (referred to as “B-Graphite”).

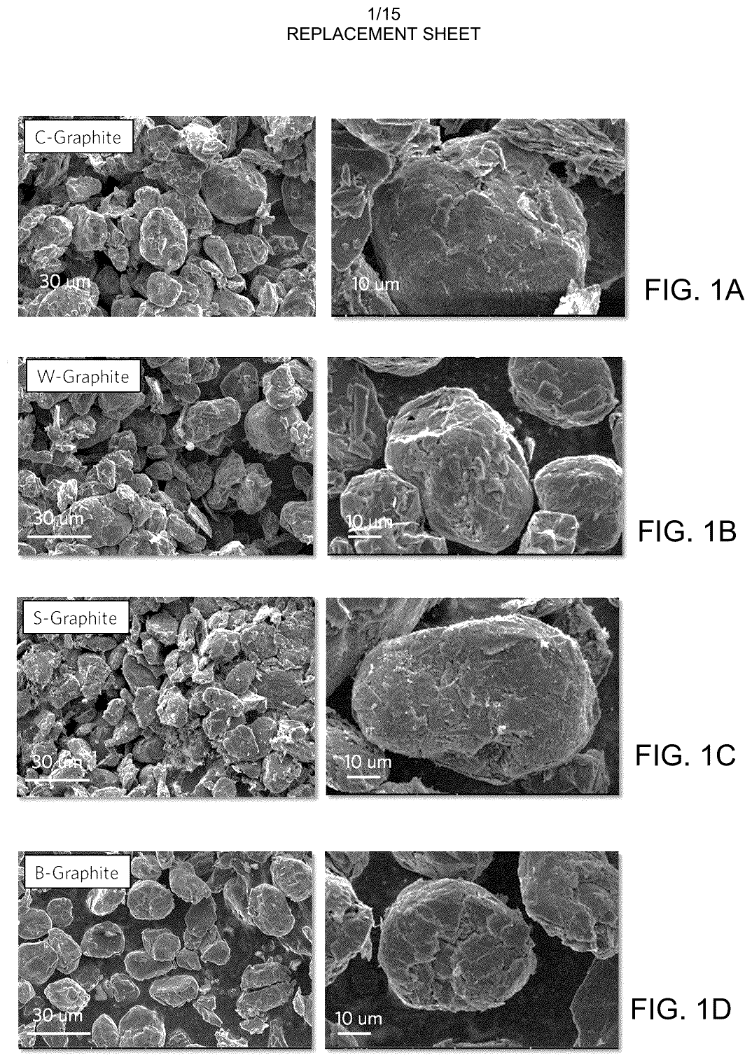

Scanning electron microscopy (SEM) imaging was applied to characterize the morphology of the C-, W-, S- and B-Graphite samples. FIGS. 1A-1D are SEM images of the graphite materials before and after regeneration with different routes. The C-Graphite exhibited irregular cobblestone-like shapes, typical of synthetic graphite, with sizes ranging from 10 to 30 μm, which indicates that the spent graphite did not undergo considerable morphological changes after cell cycling. After regeneration by washing, sintering, and boric acid pretreatment followed by sintering, the morphology did not show obvious morphology change overall. Notably, as seen in FIG. 1C, some bright spots can be observed on the surface of S-graphite, which could be associated with the decomposition products of the residual solid electrolyte interphase (SEI). However, the B-Graphite exhibits a clean surface, suggesting that the SEI was completely removed by the boric acid treatment following by a short annealing step.

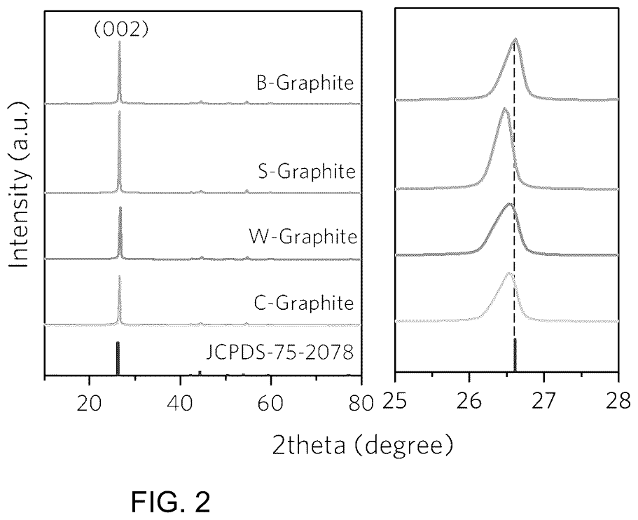

The crystal structure of cycled and regenerated graphite materials was further examined using x-ray diffraction (XRD), the results of which are shown in FIG. 2. It should be noted that the C-Graphite still displayed typical diffraction peaks of highly ordered graphite with the hexagonal crystal structure (JCPDS #75-2078, lowest line in FIG. 2), which suggests a possible direct regeneration approach for the spent graphite. In addition, no characteristic peaks from potential impurities (e.g., binder, conductive agent, copper from current collector, or SEI components) were observed. The crystallinity of graphite after sintering (S-Graphite and B-Graphite) was notably enhanced, which is reflected by the reduced peak broadening. From the enlarged view of the (002) peak, a left shift for C-, W- and S-Graphite was observed. After treatment by boric acid solution followed by short annealing, the peak shifted back to the location similar to the position of the standard PDF card of graphite.

According to the Bragg equation (2d sin θ=nλ), the interlayer distances for (002) plane (d₀₀₂) can be determined and are provided in Table 1, which lists the physical parameters of (002) peaks of C-, W-, S- and B-Graphite.

TABLE 1

| Sample | Interlayer distance (Å) | FWHM (cm⁻¹) |
|---|---|---|
| C-Graphite | 3.359 | 0.277 |
| W-Graphite | 3.360 | 0.322 |
| S-Graphite | 3.366 | 0.238 |
| B-Graphite | 3.349 | 0.240 |

It was found that the d₀₀₂ of C-Graphite (3.359 Å) is slightly larger than the standard value (3.350 Å) of typical graphite, which may be a result of the residual Li between the graphite layers after long-term cycling. The spacing of W-Graphite maintained 3.360 Å, indicating that the residual Li cannot be fully removed by the simple washing step alone. After sintering, the d₀₀₂ increased to 3.366 Å, implying the expansion of graphite interlayers in the heating process. This might be due to the conversion of the bulk Li to LiOH/Li₂CO₃ after the washing step, which decomposed and released H₂O/CO₂ during sintering, causing enlargement of the interlayer spacing. By comparison, it was found that the d₀₀₂ of B-Graphite returned to 3.349 Å, which suggests that residual bulk Li has been largely extracted during the process.

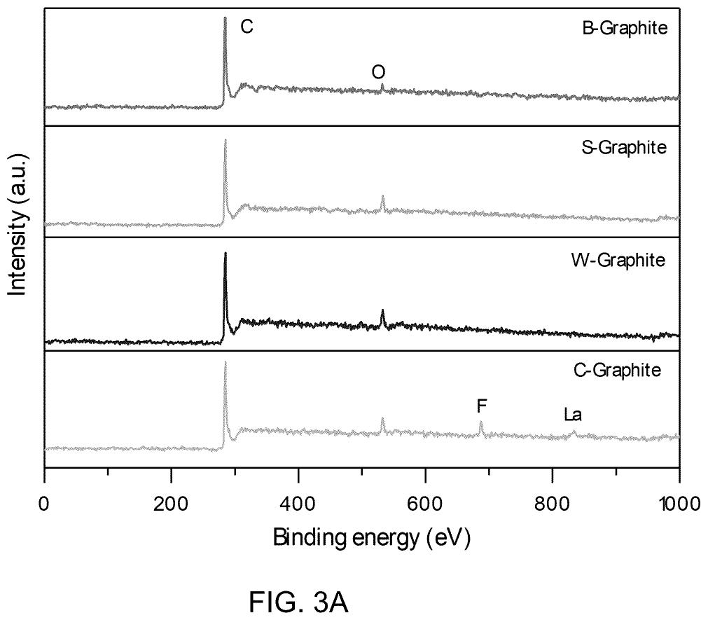

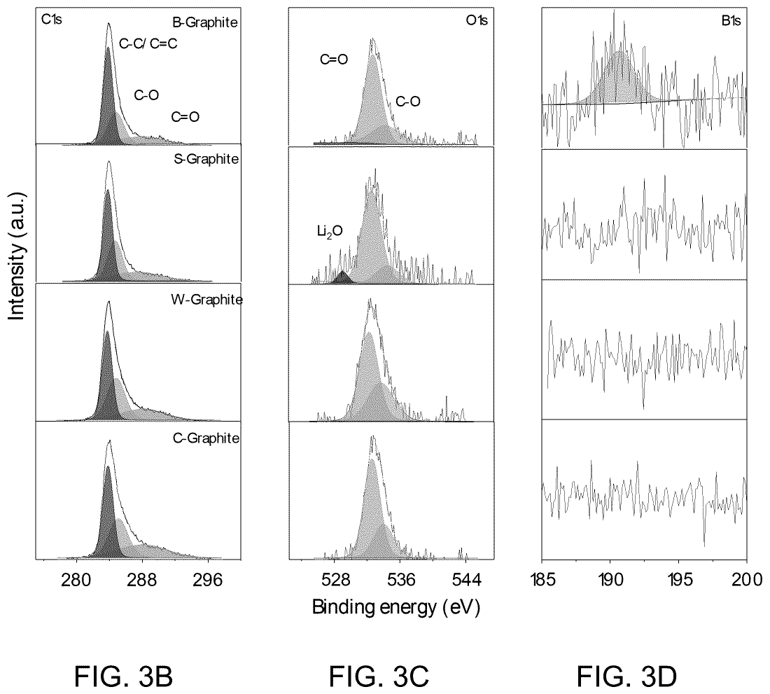

X-ray photoelectron spectroscopy (XPS) measurement was further performed to analyze the surface composition of the graphite materials. FIG. 3A depicts the survey spectra with the corresponding composition listed in Table 2, which provides the surface composition (at. %) of different graphite samples obtained from XPS spectra.

TABLE 2

| Samples | C | O | Li | F | La | B | Total |
|---|---|---|---|---|---|---|---|
| C-Graphite | 83.9% | 7.5% | 4.2% | 3.7% | 0.7% | | 100% |
| W-Graphite | 91.3% | 8.6% | 0.1% | | | | 100% |
| S-Graphite | 93.8% | 6.1% | 0.1% | | | | 100% |
| B-Graphite | 88.9% | 2.4% | 4.5% | | | 4.2% | 100% |

Specifically, 3.7 at. % of F and 4.2 at. % of Li were detected in the C-Graphite, which may be from binder (PVDF) and lithium salt (e.g., LiF) in SEI. The observation of 0.7 at. % of La in the graphite anode is probably from the cathode side (a mixture of LiMn₂O₄ and LiNi_{1-x-y}MnₓCo_{y}O₂), which is a common dopant element for improving stability of cathode materials. After washing with solvent and distilled water, all the F, Li and Co signals are almost undetectable, indicating that the surface impurities associated with SEI products have been removed. As previously noted, the solvent used in the experiments was NMP, however, other solvents may be used. After annealing, no apparent change in composition was observed for S-Graphite. Notably, for the sample pretreated with boric acid followed by short annealing, 4.5 at. % of B coupled with 4.5 at. % of Li were detected on the surface of graphite particles, suggesting that the graphite surface was modified during the processing. The formation of B can be due to the existence of Li (in the form of LiOH, Li₂CO₃ etc.) with H₃BO₃, which will react in the following pathways.

3LiOH+H₃BO₃→Li₃BO₃+3H₂O (1)

Li₂CO₃+6H₃BO₃→2LiB₃O₅+CO₂+9H₂O (2)

Although determining the exact composition can be difficult, local distribution of Li and B can be clearly identified

High-resolution XPS spectra of the C1 s, O1s, and B1s of C-, W-, S-, and B-Graphite are shown in FIGS. 3B-3D. The C1s spectra of all the samples were fit to three peaks located at 284.8, 285.9, and 289.9 eV, which are assigned to C—C/C═C, C—O, and C═O interactions, respectively. The O1s spectra of the C-, W-, and B-Graphite show similar fitting peaks at 531.98 and 533.62 eV, corresponding to C═O and C—O, respectively. However, a small peak associated with Li₂O (529.34 eV) was detected for S-Graphite, which may be attributable to the decomposition of the remaining SEI. Overall, the surface O content reduced from 7.5 at % (C-Graphite) to 2.4 at % for B-Graphite, while W- and S-Graphite still showed 8.6 at % and 6.1 at % of 0, respectively. Finally, the fine spectra of B1s are compared in FIGS. 3B-3D, where the B-Graphite exhibited a peak located at 190.4 eV, which can be ascribed to B—C bond, further confirming that boron atoms are incorporated to the graphite during the regeneration processing. It is possible that the B—C bond formation may originate from the carbon thermal reduction reaction of lithium boron oxides (LiₓB_{y}O_{z}).

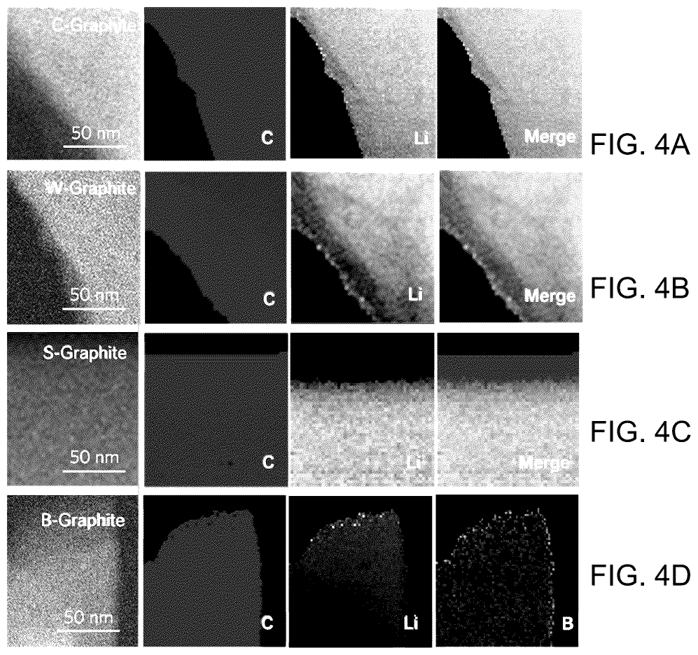

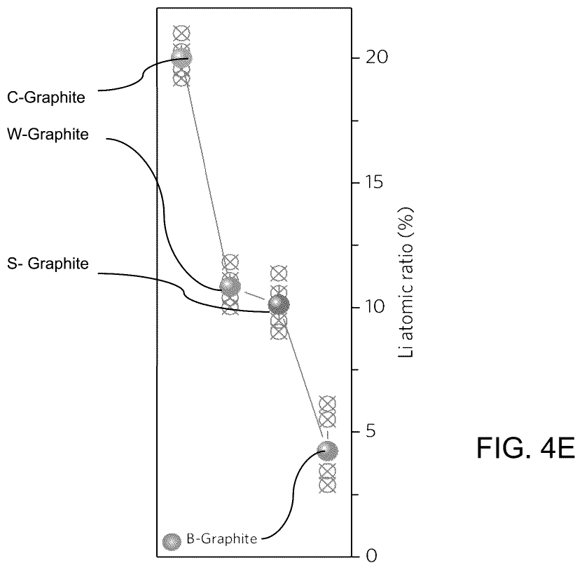

The surface distribution of B and Li elements were further probed by scanning transmission electron microscopy (STEM) combined with energy dispersive X-ray spectroscopy (EDS)—STEM-EDS. The high-angle annular dark-field STEM (HAADF-STEM) images and corresponding electron energy loss spectroscopy (EELS) elemental mapping of all the graphite samples are shown in FIGS. 4A-4D. A large amount of residual Li in the bulk of C-graphite (FIG. 4A) can be observed. This is probably because some Li⁺ ions cannot be extracted from the graphite interlayers due to kinetics restriction as well as dead Li⁺ irreversibly trapped in the structural defects such as turbostratic disorder, grain boundaries, unorganized carbons. As shown in the Li elemental mapping in FIGS. 4B and 4C, even after washing and sintering, only −10% surface-Li was removed (FIG. 4E) during processing (W- and S-Graphite). By contrast, when the C-Graphite was treated with boric acid followed by a short sintering step, the bulk-Li was completely removed and only −4.5% of Li remained on the surface, as shown in FIG. 4D.

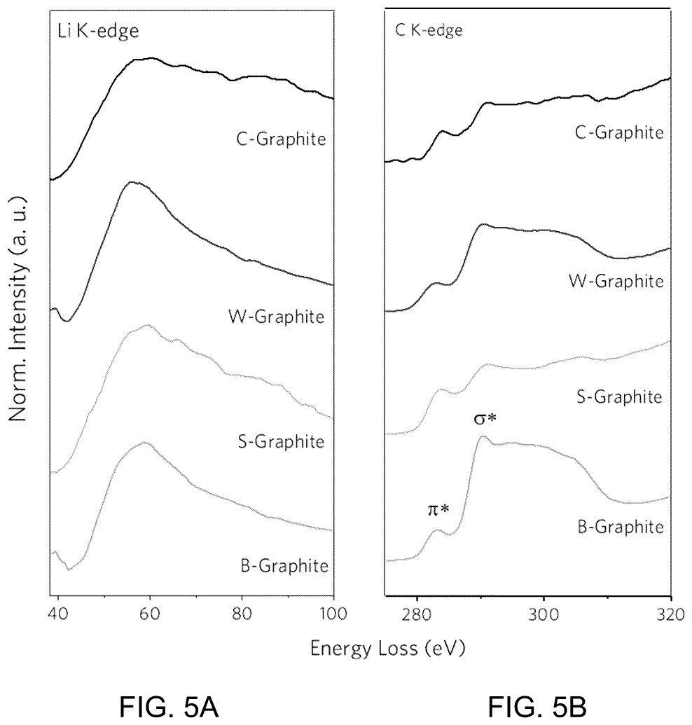

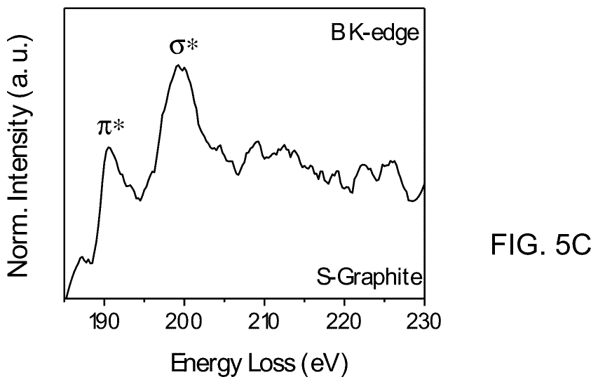

The chemical bonding information was further determined by EELS. FIGS. 5A-5C depict the EELS spectra of the characteristic K-shell ionization edges of Li, C and B, respectively. In FIG. 5A, the four samples show similar Li EELS spectra with a broad peak, however, the peaks from Li compounds (Li₂O, Li₂CO₃, LiF, LiCₓ, etc.) typically overlap, and are difficult to distinguish. Overall, the C K-edge spectra of the four samples (FIG. 5B) are analogical, which show a first peak corresponding to the 1s-π* antibonding orbital, followed by a wider band attributed to the 1s-σ* antibonding orbital, indicating a well-graphitized sp²-hybridization structure. Notably, the peak intensity based on the Li K-edge for each sample is normalized. Consequently, the peak intensity evolution of C K-edge in different samples represent the C/Li atomic ratio. The much higher C K-edge intensity for the borate treated sample qualitatively indicates the effective bulk Li removal compared with the cycled sample.

The EELS spectrum of the B K-edge was also collected and is shown in FIG. 5C, where two intense peaks were observed. The first peak at 190.4 eV is ascribed to the 1s-π* resonance, and the second peak at 199.5 eV is due to the 1s-σ* interactions, which demonstrates the presence of the sp 2 and sp a hybridization of boron in the hexagonal boron/carbon conformation. Hence, it was concluded that the B element on the surface of B-Graphite was bonded with carbon atoms, forming a BCₓ compound, which is consistent with the XPS result in FIG. 3D. The B-doping on the graphite edge provides one less electron compared with pure graphite material. The Li can be considered as an electron donor to fill the unoccupied states, which accordingly can lead to extra lithium absorbed on the edge of graphite particles (FIG. 4D).

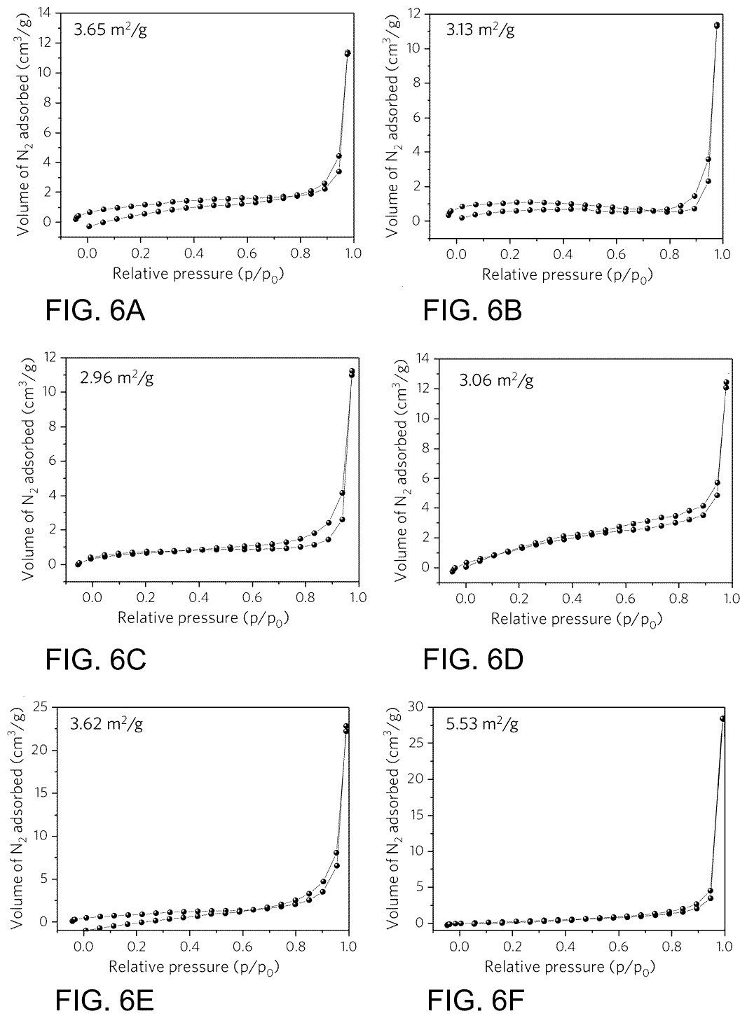

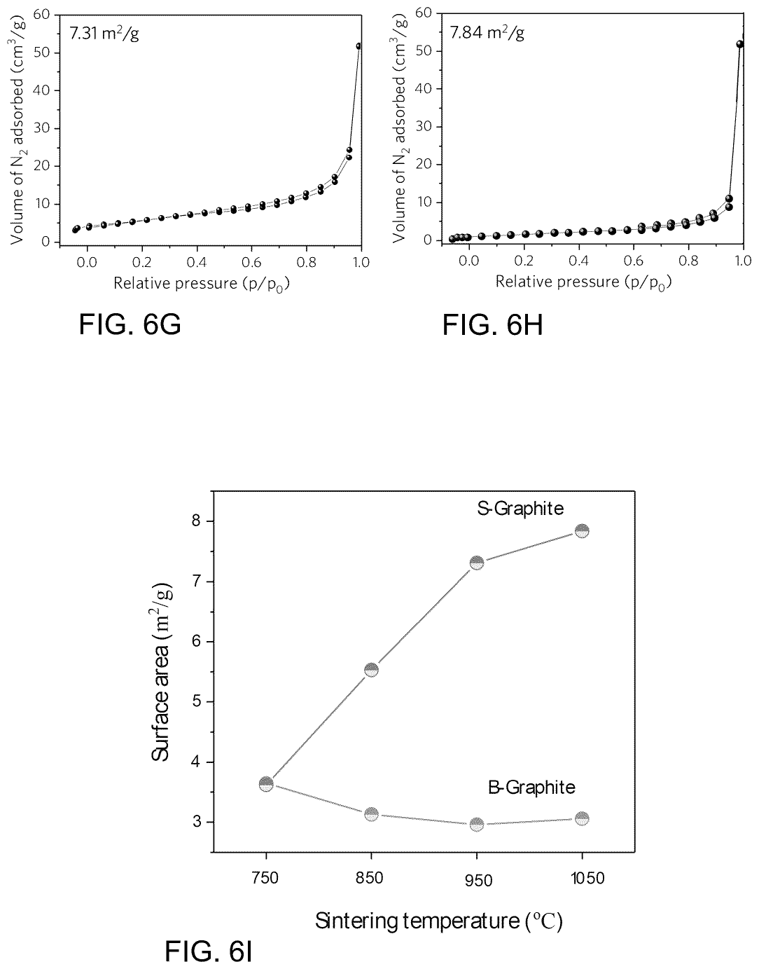

The surface area, a critical parameter affecting the stability of LIB anode, of all S-Graphite and B-Graphite samples obtained at different annealing temperatures was probed by N₂ adsorption/desorption experiment. FIGS. 6A-6D provide the N₂ adsorption/desorption isotherms for B-Graphite, where B-750C-Graphite (FIG. 6A), B-850C-Graphite (FIG. 6B), B-950C-Graphite (FIG. 6C) and B-1050C-Graphite (FIG. 6D) are shown. The B-750C-Graphite showed a specific surface area of 3.65 m²/g, which decreased to 2.96 m²/g as the annealing temperature was increased to 950° C. As the temperature was further increased to 1050° C., a negligible increase was observed (3.06 m²/g). The low specific surface area is favorable for improving the Coulombic Efficiency.

For the S-Graphite samples shown in FIGS. 6E-611, the Brunauer-Emmett-Teller (BET) surface area (S_{BET}) of S-Graphite increased from 3.62 to 7.84 m²/g as the annealing temperature increased from 750° (FIG. 6E) to 1050° C. (FIG. 611). In contrast, the S_{BET} of B-Graphite reduced from 3.65 to 3.06 m²/g for the same change of annealing temperature. These results agree with the XRD data provided in Table 1, that the interlayer spacing of S-Graphite expanded compared with typical graphite while the spacing remained the same for B-Graphite. It should be noted that a large specific surface area is not advisable for graphite due to increased decomposition of electrolyte.

These results are consistent with the XPS results that the surface O content of S-Graphite is significantly higher than that of B-Graphite. Thus, the surface modification of graphite with boron can significantly restrict the increase of surface area with increased sintering temperature compared with S-Graphite, as shown in FIG. 61.

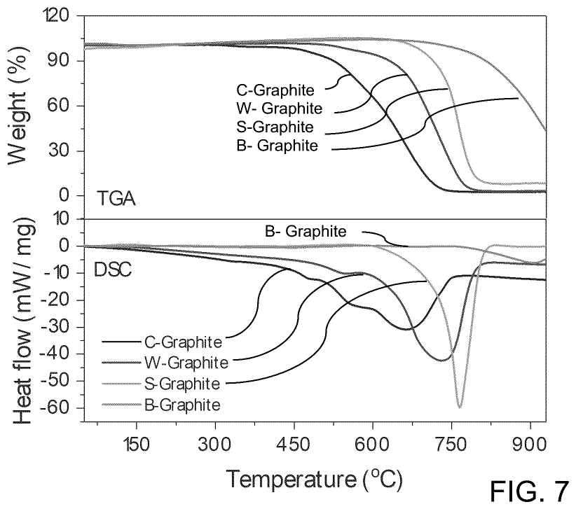

The thermal stability of graphite materials was further explored by thermogravimetric analysis (TGA), which was carried out by heating from room temperature to 900° C. with a heating rate of 10° C./min under an oxygen atmosphere. Meanwhile, the differential scanning calorimetry (DSC) was also collected as well, which is favorable to further determine the composition of graphite materials. The TGA and DSC curves are plotted in FIG. 7. The C-Graphite exhibited a weight loss of ˜2 wt. % between 100 and 350° C., coupling with a broad DSC thermogram peak in this temperature window, which can be ascribed to the evaporation of physically adsorbed water. The weight loss of 4 wt. % between 350 to 550° C., accompanying with a DSC thermogram peak located at −475° C., can be attributed to pyrolysis of PVDF binder. A clear DSC thermogram peak at ˜570° C. associated with LiOH can be observed. However, the related weight loss cannot be quantified accurately because it was combined with a dramatic weight decrease caused by the combustion of carbon. After washing, the DSC thermogram peak related to PVDF disappeared, suggesting the binder was completely removed from the graphite sample, which is consistent with the XPS result. The thermogram transition at ˜570° C. indicated that the lithium in W-Graphite was present as LiOH. For the S-Graphite, only a sharp endothermic peak at ˜760° C. associated with the combustion of graphite appeared. It should be noted that there was a remaining 8 wt. % of substance after graphite was burned out. It is believed to be Li₂O converted from LiOH, which can be thermally stable over the measured temperature range. Interestingly, the B-Graphite was found to be stable up to 700° C., which may be due to the stabilizing effect of boron on the surface of graphite. In this sample, atmospheric oxygen would preferentially react with boron due to its lower electronegativity when compared to carbon, forming boron oxide. The boron oxide could serve as a physical diffusion barrier, reducing the oxidation rate of graphite. Thus, the B-Graphite was not completely burned out even when it was heated to 900° C. and the corresponding thermogram peak did not show up completely.

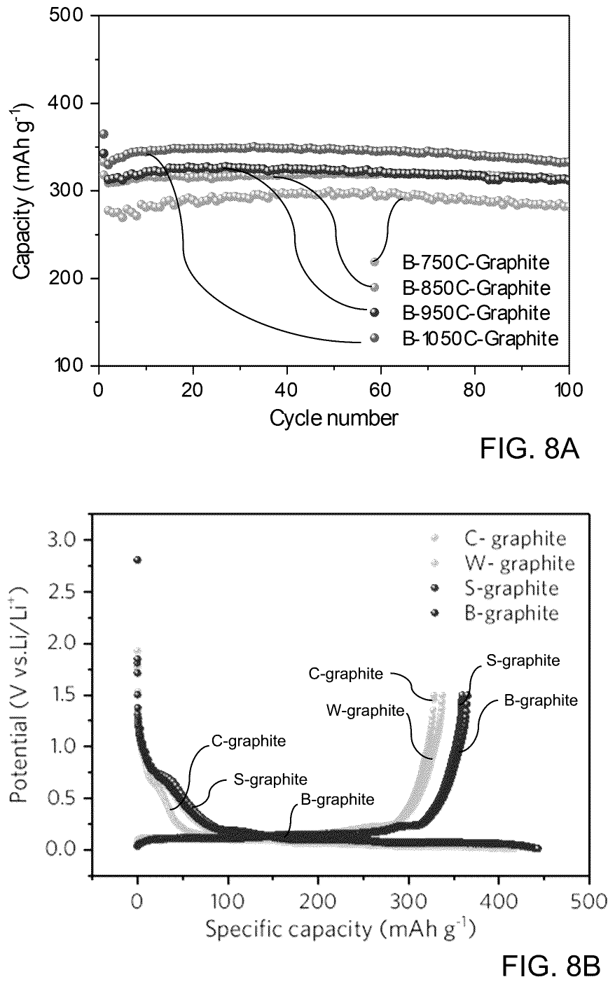

The electrochemical performance of cycled and regenerated graphite was studied with half-cells under the galvanostatic cycling. The cycling stability of the B-graphite sintered at different temperatures was tested, with the results plotted in FIG. 8A. The capacity of all samples showed an increasing trend during the initial cycles due to activation process and then tended to stabilize. The B-Graphite sintered at 1050° C. exhibited an increased average capacity of 332 mAh/g (at C/3) compared with the samples sintered at lower temperatures (279 mAh/g for B-750C-Graphite, 310 mAh/g for B-850C-Graphite and 312 mAh/g for B-950C-Graphite), which might be attributable to the increased ordering of graphite layers and decreased structural defects.

The charge and discharge curves of C-, W-, S-, and B-Graphite were compared in FIG. 8B. All samples showed a small plateau between 0.8 V-0.6 V in the discharge process, which is associated with the formation of SEI, and a long plateau between 0.2 V to 0.02 V, which can be assigned to intercalation of Li⁺ in graphite interlayers. It should be noted that the first plateau of the S-Graphite was the longest among all the samples, accounting for 5% of the total discharge capacity, which leads to a lower Coloumbic efficiency (80%) than the other three samples (83% for C-Graphite, 81% for W-Graphite, 82% for B-Graphite). This is consistent with the highest S_{BET} of S-Graphite among all the graphite samples. Despite this efficiency, the C-Graphite exhibited a reduced ability to host fresh Li⁺ due to the residual dead Li in the bulk graphite, which occupied the active sites between the graphite interlayers, leading to a reduced discharge capacity of only 295 mAh/g.

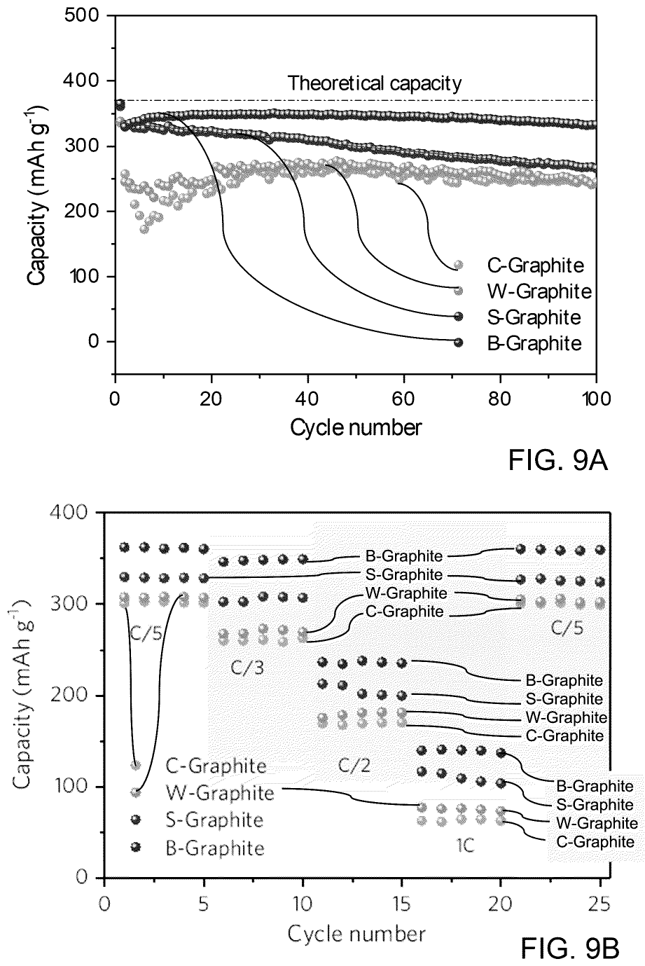

The cycling stability and rate capability of the C-, W-, S- and B-Graphite are further compared in FIGS. 9A and 9B. The S-Graphite was found to deliver a capacity of 331 mAh/g at a C/3 rate, however, only 265 mAh/g was retained after 100 cycles. A possible cause is the increased specific surface area after sintering at 1050° C., leading to more parasitic reactions and gradual capacity degradation. It was interesting to find that the surface doping of boron not only improved the initial capacity to 330 mAh/g but also retained the capacity to be 333 mAh/g after 100 cycles. This may be due to the fact that, after subtraction of the bulk-Li during the regeneration process, the occupied active sites between the graphite interlayers and grain boundaries were released.

Since the removal of bulk residual Li reopens the channels for Li transport, the rate capability was also enhanced. The average capacity delivered by the B-Graphite was 362, 348, 234 and 140 mAh/g at rates of 0.2 C, 0.3 C, 0.5 C and 1 C, respectively. Furthermore, when the rate was returned to 0.2 C, a capacity of 358 mAh/g was retained. By comparison, when the rate was increased to 1 C, only 108, 74 and 64 mAh/g was exhibited by the S-Graphite, W-Graphite and C-Graphite, respectively.

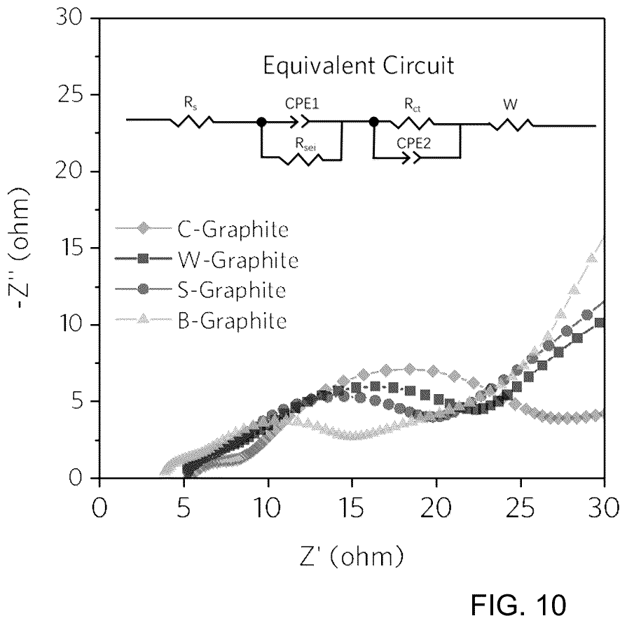

EIS was then implemented to investigate the electrochemical kinetics of cycled and regenerated graphite martials. Nyquist plots, shown in FIG. 10, were fitted with the equivalent circuit (inset) to obtain quantitative values of resistances Rₛ, R_{SEI}, and R_{ct}, referring to the internal resistance of electrode and electrolyte, SEI film resistance, and charge transfer resistance, respectively. CPE (constant phase element) is used to supplement non-ideal capacitor behavior. W is the Warburg impedance, which is also known as the diffusion resistance. The C-Graphite displayed the largest R_{ct} (16.3Ω), which is likely attributed to the remaining impurity species in the cycled graphite material. After washing, the R_{ct} of W-Graphite was reduced to 14.6Ω, which is owing to the removal of PVDF binder from the graphite particle. After sintering at 1050° C., although the R_{ct} was further reduced to 13.6Ω, it was still much higher than that of B-Graphite (8.6Ω). This may be due to the dead Li residual inside the graphite particle, which would lead to high electrochemical polarization, resulting in capacity loss especially at high charging/discharging rate. The above results are consistent with the established understanding of graphite anode that the interface of graphite and electrolyte is the first barrier that the Li ions need to diffuse through, and the edge features and disordered carbon structure significantly affect the Li⁺ intercalation behavior. The B-doping surface modifies the local electronic structure and tailor interface properties, which correspondingly enhances the rate and durability.

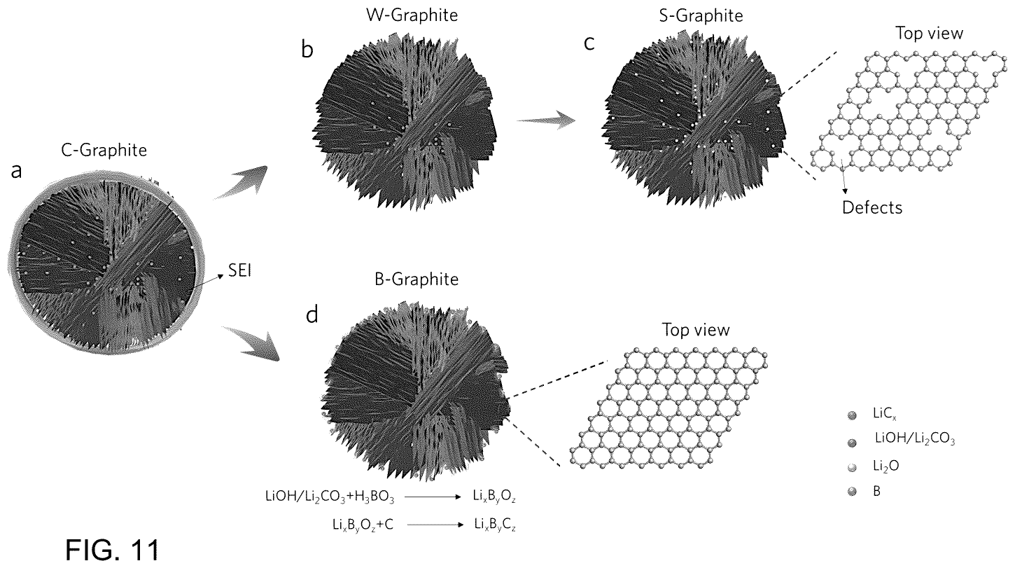

The above-discussed mechanisms of the various regeneration processes are summarized and illustrated in FIG. 11. Testing determined that the reversible Li⁺ loss accounting for the battery capacity decay is attributable to not only the formation of SEI and but also the Li⁺ trapped in the graphite bulk (turbostratic structures, edge sites, grain boundaries, etc.), as shown in panel a. After washing with solvent and distilled water, the surface SEI can be largely removed. However, a significant portion of the bulk Li likely remains, occupying or blocking the active sites of graphite interlayers and disordered carbon structures, which sacrifice the usable capacity (panel b). After further sintering at high temperature, the specific surface area was increased, which might be caused by induced defects by the removing residual bulk-Li (panel c). In contrast, the boric acid treatment followed by sintering not only completely extracts dead Li in the bulk structure of graphite particles, but also modifies the graphite surface with boron doping, which largely improves the thermal stability and minimize the surface area, leading to high electrochemical activity and cycling stability.

An effective scheme for the upcycling of spent graphite anodes was identified by leveraging fundamental understanding of the evolution of structural and compositional defects in different regeneration processes. The approach that led to this improvement used advanced characterization methods to determine that the residual Li in the bulk of degraded graphite particles is mainly responsible for the capacity deficiency of regenerated spent graphite by simple washing and sintering process. The use of boric acid solution treatment followed by short annealing enables complete regeneration of fine structures of spent graphite as well as introducing functional B-doping, thus providing both high electrochemical activity and excellent cycling stability. Considering the low cost, non-volatile and non-caustic nature of boric acid as well as the simple process, the inventive approach represents a promising vehicle for green and sustainable recycling of spent LIB anodes.

1. A method for removing bulk defects from spent graphite particles from a Li-ion battery anode, comprising:
treating the spent graphite particles in a boric acid solution to form borated graphite particles;
drying the borated graphite particles; and
fast annealing the borated graphite particles.

2. The method of claim 1, further comprising, prior to the step of treating, washing the spent graphite particles in a solvent and drying to form a powder.

3. The method of claim 1, wherein the step of fast annealing comprises sintering the borated graphite particles for approximately an hour at a temperature in a range of 750° C. to 1050° C.

4. A method for restoring electrochemical activity and cycling stability to spent graphite anode material for use in a lithium-ion battery comprising:
exposing powdered graphite anode material to boric acid to form borated material; and
sintering the borated material, wherein dead lithium in a bulk structure of the graphite anode material is extracted and boron doping is applied to surfaces of the graphite material.

5. The method of claim 4, further comprising, prior to the step of exposing, washing the spent graphite particles in a solvent and drying to form a powder.

6. The method of claim 4, wherein the step of sintering comprises annealing the borated material for at least one hour at a temperature in a range of 750° C. to 1050° C.

7. A method for regeneration of spent anode material of a lithium-ion battery comprising:
harvesting graphite particles from the spent anode material;
washing the harvested graphite particles in a solvent solution;
precipitating graphite powder from the solution;
rinsing the graphite powder in water;
drying the graphite powder;
dispersing the graphite powder in a boric acid solution;
exposing the borated graphite powder to a drying temperature until dry; and
sintering the dried borated graphite powder at a sintering temperature for a sintering period.

8. The method of claim 7, wherein washing the graphite particles in the solvent solution further comprises heating the solution at a temperature of 70-90° C. until dried.

9. The method of claim 7, wherein the sintering temperature is within a range of 750° C. to 1050° C.

10. The method of claim 7, wherein the sintering period is at least one hour.

11. A method for removing bulk residual lithium and reopening channels for lithium transport from graphite anode material of a spent Li-ion battery comprising:
exposing powdered graphite anode material to boric acid to form borated material; and
sintering the borated material, wherein boron doping is applied to surfaces of the graphite material.

12. The method of claim 11, wherein the step of sintering comprises annealing the borated material for at least one hour at a temperature in a range of 750° C. to 1050° C.
